(19) United States
(12) Patent Application Publication
(10) Pub. No.: US 2007/0150305 A1
(43) Pub. Date: Jun. 28, 2007

(54) Method for selecting a potential participant for a medical study on the basis of a selection criterion

(76) Inventors: Klaus Abraham-Fuchs, Erlangen (DE); Eva Rumpel, Erlangen (DE); Markus Schmidt, Numberg (DE); Siegfried Schneider, Erlangen (DE); Horst Schreiner, Furth (DE); Gudrun Zahlmann, Neumarkt (DE)

Correspondence Address: HARNESS, DICKEY & PIERCE, P.L.C., P.O.BOX 8910, RESTON, VA, 20195, US

(21) Appl. No.: 10/589,537

(22) PCT Filed: Feb. 1, 2005
(86) PCT No.: PCT/EP05/50409

§ 371 Date: Aug. 16, 2006

(30) Foreign Application Priority Data
Feb. 18, 2004 (DE) 10 2004 008 192.1
Oct. 28, 2004 (DE) 10 2004 052 474.2

(51) Int. Cl. G06Q 10/00; G06F 17/20

(52) U.S. Cl. 705/2; 704/8

(57) ABSTRACT

During a method for selecting a potential participant for a medical study on the basis of a selection criterion, patient data assigned to a patient are electronically stored. A secondary criterion is assigned to the selection criterion. The patient data are electronically evaluated on the basis of the secondary criterion. Based on this electronic evaluation, a measure for fulfilling the selection criterion is determined for the patient associated with the patient data. The patient is selected as a potential participant on the basis of this measure.

### PRIORITY STATEMENT

This application is the national phase under 35 U.S.C. § 371 of PCT International Application No. PCT/EP2005/050409 which has an International filing date of Feb. 1, 2005 which designated the United States of America and which claims priority on German Patent Application numbers 10 2004 008 192.1 filed Feb. 18, 2004, and 10 2004 052 474.2 filed Oct. 28, 2004, the entire contents of which are hereby incorporated herein by reference.

### FIELD

The invention generally relates to a method for selecting a potential participant for a medical study on the basis of a selection criterion.

### BACKGROUND

In hospitals, medical practices, medical research facilities and the like, more and more medical studies are being carried out for which patients have to be recruited as participants. Examples of these studies include research work, clinical studies, drug approval trials, etc. In these, new medicaments, treatment methods, diagnostic procedures, etc., are tested on the participating patients.

To be able to achieve comparable results in studies of these kinds, the participating patients, or participants, have to be comparable or correspond in terms of certain characteristics. These characteristics are therefore set down in selection criteria on which the medical study is based. A certain type of patient is specified by the selection criteria. Selection criteria can include both inclusion and exclusion criteria. To be considered as a participant, a patient absolutely has to meet the inclusion criteria and must not have the exclusion criteria.

Hitherto, participants have been selected by members of the medical personnel for example, or other persons authorized to recruit participants, carrying out the lengthy and laborious task of manually going through patient files in paper form, or patient files which are electronically stored but unstructured, in order to examine them in respect of the selection criteria. Unstructured in this context means that no standardized form of data storage has been followed and no standardized terms, data fields, etc., have been used.

Highly structured electronic patient databases are also searched for the selection criteria. Highly structured in this context refers to the patient data being stored according to standardized terms and in standardized format, e.g. all diagnoses are cited using the associated ICD code, or all the patient data are strictly ordered in corresponding data fields. In this case, the electronic search is often limited to a search using the selection criteria as key words, in much the same way as in an internet search using a search engine.

An even more difficult task is, for example, a search through electronic image archives in which tumor patients, for example, are intended to be found on the basis of MR or CT images.

The problem with these various alternatives is that the manual search for participants in patient files is difficult and time-consuming, and therefore expensive, and only a small number of patients are included in highly structured databases. The selection of potential participants for the medical study is therefore ineffective, slow and costly, and requires extensive use of personnel. In a new search, the entire procedure has to be repeated, even in cases where, for example, the selection criteria deviate only slightly from earlier selection criteria.

### SUMMARY

At least one embodiment of the present invention improves the selection of a potential participant for a medical study on the basis of a selection criterion.

A method, in at least one embodiment, is for selecting a potential participant for a medical study on the basis of a selection criterion. In this method, patient data assigned to a patient are electronically stored, a secondary criterion is assigned to the selection criterion, the patient data are electronically evaluated on the basis of the secondary criterion, and, based on this electronic evaluation, a measure for fulfilling the selection criterion is determined for the patient associated with the patient data, and the patient is selected as a potential participant on the basis of this measure.

Patient data include all the medical data or other types of data correlated with the patient, for example diagnostic images (X-ray, CT, ultrasound), textual documents in structured form, e.g. table format, or in the form of continuous text (diagnoses, prescriptions, physicians' letters, examination protocols), measured values (laboratory data, electrophysiology data), the patient's personal data (age, sex, height), or other individualized data (socio-economic data, census data).

By way of the electronic storage of patient data, these data can be searched electronically, for which reason the method according to at least one embodiment of the invention can be carried out automatically, rapidly, effectively and with minimal output in terms of time and personnel. Hitherto, data of this kind could not be electronically searched in connection with the selection of patients for medical studies.

The following procedure is known and is not the subject of the embodiments of the invention. If the selection criterion is contained in the electronically stored patient data, then the associated patient meets this criterion completely and is thus entirely suitable as a participant, and is therefore selected. Or the patient is completely rejected as a participant if, according to the patient data, he does not meet the inclusion criteria contained in the selection criteria, or he meets the exclusion criteria. Such patients can therefore be selected or rejected as potential participants in a straightforward, quick and inexpensive way.

Moreover, a great many patients also exist whose patient data do not contain with certainty the selection criteria, for example because these selection criteria are not explicitly mentioned. At least one embodiment of the invention starts out from the recognition that many of these patients nevertheless satisfy the selection criteria, even if this is not explicitly evident from the patient data.

For this reason, each selection criterion is assigned a secondary criterion which, it is hoped, is contained in the patient data. Since the secondary criterion is assigned to the selection criterion. Thus, after a secondary criterion is found in the patient data, it is possible to infer the existence of the corresponding selection criterion in respect of the patient, namely whether this patient reliably fulfills the selection criterion with a certain probability or not.

The patient data are therefore electronically evaluated on the basis of the secondary criterion, i.e. a check is made to ascertain whether the patient data satisfy the secondary criterion or not. Depending on the nature of the secondary criterion and on the correlation with the selection criterion, it is possible, whether the patient data agree or do not agree with the secondary criterion, to determine a measure for the associated patient which provides a conclusion on to what extent the patient meets the selection criterion. On the basis of this measure, the patient may or may not be selected as a potential participant. A wide variety of measures are conceivable for this assessment. The measure can be expressed in words such as “very suitable” or “very unlikely”, or can be entered on an assessment scale.

Both the selection criterion and the secondary criterion can include one or more subcriteria, i.e. several secondary criteria can be assigned to one selection criterion, for example.

On searching the patient data for the secondary criterion, it is possible not only to find the patients who satisfy the selection criterion directly, but also those who, although satisfying the selection criterion, do not have this mentioned directly in the patient data. For a medical study, therefore, more suitable participants are selected and are made available for said study. The feasibility of the medical study is thus increased.

Once patient data have been recorded in electronic form, they cannot be overlooked or forgotten in a search for participants. The search for participants can take place automatically, for example by computer, without personnel being needed to search through the patient data. For further medical studies, the patient data can be searched again, virtually without any additional output in terms of personnel and time, and they do not have to be digitalized again.

There are many possible ways of assigning a secondary criterion to a selection criterion, the only common aspect having to be that the examination of a patient and of his patient data for the secondary criterion allow conclusions to be drawn on how the patient fulfills the selection criterion. The following advantageous ways of assigning a secondary criterion to a selection criterion are given as examples, without any claim to this list being complete:

The secondary criterion can be assigned to the selection criterion according to known medical correlations. In such a case, the selection criterion is a medical state of the patient, a diagnosis or the like.

According to known medical correlations, these conditions or diagnoses involve, as example of the secondary criterion, concomitant diseases, certain drug prescription, therapies, laboratory data, etc. By checking the patient data for the secondary criteria according to these correlations, it is possible, in most cases with a certain probability, often even with certainty, to drawn conclusions on whether the patient in question fulfills the selection criterion. As a measure of the fulfillment of the selection criterion, it is possible, for example, for the aforementioned probability of the joint occurrence of selection criterion and secondary criterion to be assigned to the patient, if the latter meets the secondary criterion.

Many medical correlations of this kind are known and have been conclusively proven. By integrating such correlations into the method according to at least one embodiment of the invention, a multiplicity of patient characteristics can be assigned to a selection criterion so that a large number of patients can automatically be found as potential participants for a medical study.

The secondary criterion can be assigned to the selection criterion on the basis of linguistically employed medical terms. The patient data are then evaluated on the basis of the secondary criterion with a classification algorithm. Especially when the patient data are digitalized examination reports, brief notes or other written records made by a physician, they often do not contain the standardized diagnostic terms, ICD codes or such like specified as the selection criterion, but instead use terms taken from the physician's own preferred vocabulary. This can vary greatly between different countries and regions.

In documents of these kinds, the selection criterion cannot be found, even though synonymous terms are contained once or several times in the patient data. These are selected as secondary criterion. A suitable classification algorithm, for example a computer-based ontology or a Bayes classification, can then search for terms synonymous with the selection criterion, in a manner comparable to a medical thesaurus.

Patient data containing different vocabulary, but signifying the same patient characteristic, can thus be recognized together and assigned to a selection criterion. In this way too, a larger number of patients can be found who correspond to the selection criterion. Differences in the way the medical characteristics of a patient are recorded and written down can thus be compensated for and made uniform.

The secondary criterion can be assigned to the selection criterion according to nonmedical correlations concerning the medical study. Thus, in addition to checking the selection criteria in medical respects, it is possible to further limit the potential participants for the medical study, for example by employing empirical values which show that certain groups of persons are generally more suitable for certain studies than is another group. Corresponding secondary criteria can be, for example, the patient's age, level of education, and the social stratum to which he or she belongs, etc. Even patients who completely satisfy the selection criteria can in this way be arranged in an order that shows the degree to which they are suitable as participants for a medical study. A service provider, who is commissioned for example by the organizer of a medical study to recruit patients, is thus in a position to enlist truly reliable participants for this study.

A probability value can be determined as a measure of how the patient fulfills the selection criterion. A numerical value of between 0% and 100% is thus determined as the degree of fulfilling the selection criterion. This permits two method variants.

In the first one, a probability value of 100% or 0% is determined as the measure. The patient selected as a potential participant is then selected as an actual participant (in the case of 100%) or is rejected (in the case of 0%).

Both results provide a certain conclusion to the effect that the patient meets or fails to meet the selection criterion. Further checks regarding the selection criterion are thus dispensed with.

A method variant of this kind can be completely automated, since no further checks of the patient as suitable participant have to take place.

The determination of a measure of 0% or 100% is possible especially when the secondary criteria (one or more in combination) correspond completely to the selection criterion in terms of their expressiveness.

In the second method variant, a probability value other than 100% or 0% is used as the measure, that is to say no certain conclusion is possible on whether the patient is suitable or not as a potential participant. From the stored patient data, it is therefore not possible to determine with certainty whether the patient is suitable as a participant or not. Therefore, the latter is initially selected only as a potential participant.

For the patient selected as a potential participant, a measure with a probability value of 100% or 0% therefore has to be determined on the basis of other than the stored patient data, so that the patient selected as a potential participant can then be selected as an actual participant or can be rejected. Data other than the stored patient data can be, for example, a separate manual check of paper files, a specific reexamination of the patient, questioning of the physician in charge who recorded the patient data, and so on.

Overall, both example embodiments of method variants, applied to a patient database, provide lists of patients who, according to the first example embodiment of a method variant, can be selected or rejected as participants with certainty, or who, in the second example embodiment of a method variant, appear as potential participants and, depending on their degree of suitability, can be finally selected or rejected.

A person or organization charged with the selection of participants for the medical study can, according to the second example embodiment of a method variant for example, initially make use of the preselection of patients according to this method and does not have to manually check all the available patients. Thus, only the small number of patients whose measure lies near 100% need to be checked more closely in order to select or reject them with certainty. The time needed for the manual checking of patients is thus considerably reduced.

Unstructured medical documents which are assigned to a patient can be digitalized and stored as the patient data. The digitalization and storage of such documents in electronically scannable form has to be done just once in order in future to check these patients, by the method according to an example embodiment of the invention, for their suitability as participants in any other medical studies. In other words, the unstructured medical documents do not have to be manually searched again each time. Unstructured in this context means that no specific nomenclatures, ontologies, standardized terms, ICD codes or such like were taken into account when the documents were written or created.

Such documents were hitherto unsuitable for automatic checking. These can also include image material, such as X-rays, CT images, genomics/proteomics data or the like, which, for example, were recorded under nonstandardized conditions.

### BRIEF DESCRIPTION OF THE DRAWINGS

The invention is described in more detail with reference to the illustrative embodiments in the drawing, in which:

FIG. 1 shows a schematic flow chart of a method for selecting suitable patients as participants for a clinical study.

### DETAILED DESCRIPTION OF THE EXAMPLE EMBODIMENTS

In the present example, a clinical study is to be carried out in order to test a new diabetes medicine. Suitable patients are sought as participants for the study. These patients must satisfy selection criterion 2 including subcriteria 3a-c, of which the first two are inclusion criteria and the last one is an exclusion criterion: diagnosis of diabetes type II and associated ICD code/age between 40 and 60/no chronic high blood pressure. The selection of the participants in the study is to be done electronically.

For this purpose, a database 4 is available containing patient data 6a-f which are each assigned to a respective patient 8a-f. The patient data 6a-f include unstructured medical documents which are digitalized and stored in the database 4, for example diagnostic images, textual documents (diagnoses, prescriptions, physicians' letters, etc.), measured values (laboratory data, electrophysiology data, etc.). In this context, the word unstructured means that the patient data 6a-f differ from one another in their text structure, choice of terms, composition, number of subdocuments, etc, that is to say are not uniform.

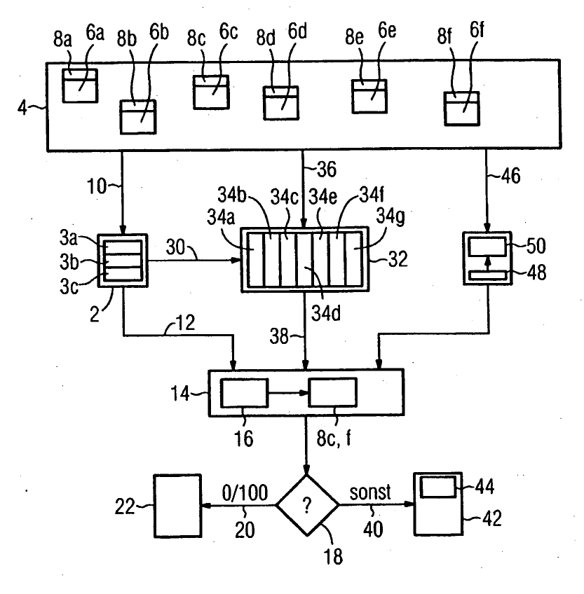

In order to find those of the patients 8a-f who are suitable as participants for the clinical study, they are first examined directly in respect of the selection criteria 2. In FIG. 1, this is shown in the left flow path. As is indicated by the path 10, the patient data 6a-f are examined directly for the selection criterion 2. On searching the database 4, a patient 8c is located via the path 10 because this patient's patient data 6c explicitly mention the ICD code for type II diabetes in a diagnostic report, the patient's age is given as 55 years, and a second examination report states that the patient 8c does not have chronic high blood pressure. All three subcriteria 3a-c are therefore precisely satisfied in patient 8c.

By way of the path 12, therefore, the patient 8c is assigned a selection measure 16 of 100% in an assessment step 14, which shows that the patient 8c satisfies the selection criterion 2 by 100%.

In an examination step 18, the selection measure of the patient 8c is interrogated. Since the measure of 100% permits a reliable selection of the patient 8c, the flow is branched via the path 20 to the selection step 22, and the patient 8c is selected as a study participant.

A further patient 8f is located via the path 10 because this patient's patient data 6f satisfy the subcriteria 3a and b, namely his age is given as 42 years and the diagnosis includes type II diabetes. However, the patient 8f certainly does not satisfy the exclusion criterion in the form of subcriterion 3c since, in a further examination protocol, this patient is diagnosed with chronic high blood pressure. By way of the path 12, therefore, the patient 8f is assigned the selection measure 16 of 0% in the assessment step 14. Thus, the patient 8f is certainly unsuitable for the clinical study.

Therefore, the examination step 18 likewise goes via the path 20 to the final step 22 in which the patient 8f is rejected as a study participant. The selection criteria 2 cannot be located in the patient data of the other patients 8a,b,d,e. These patients cannot therefore be assessed in terms of the selection criteria via path 10.

Therefore, as is indicated by the arrow 30, a secondary criterion 32 with several subcriteria 34a-g is assigned to the selection criterion 2.

For subcriterion 3a, namely type II diabetes or associated ICD code, the following direct medical relationships are known: Type II diabetes involves a laboratory blood sugar value which is greater than 150 mg/dL glucose. This criterion forms the subcriterion 34a in the secondary criterion. It is also known that, in type II diabetes, a series of medications are generally prescribed which, as medication list, form the subcriterion 34b. Subcriterion 34c involves the diagnosis of “open leg”, which is a typical sequela in diabetic patients.

The subcriterion 3b, namely the age of the patient, is included as subcriterion 34d in the form of a check of the date of birth. The subcriterion 3c, namely chronic high blood pressure, is assigned as its subcriterion 34e a list of medicaments that are usually prescribed to patients with high blood pressure.

As is indicated by the path 36, the database 4 and the patient data 6a-f are now examined for the secondary criterion 32. As is indicated by the path 38, the following selection measures 16 are then assigned in the assessment step 14: The patient data 6a include a blood sugar concentration of 180 mg/dL glucose measured on patient 8a, for which reason this patient is assigned a selection measure 16 of 100% in respect of subcriterion 34a. The age criterion, namely the subcriterion 34d, is also satisfied by the patient 8a, for which reason a selection measure 16 of 100% is also assigned in this respect too.

From the list of medicaments for high blood pressure (subcriterion 34e), none can be found in the patient data 6a. However, since this statement does not serve as a reliable conformation that the patient 8a does not have chronic high blood pressure, the subcriterion 34e is only assigned a selection measure 16 of 90%. The three determined selection measures 16 are multiplied, so that the patient 8a is finally assigned a selection measure of 100%*100%*90%=90%.

The test step 18 does not therefore deliver a result of 0% or 100%, for which reason the method runs via path 40 to a confirmation step 42. In confirmation step 42, the patient 8a is first entered with his associated selection measure 16 into a list 44 of potential participants, but patients to be still more closely examined. On completion of the method, the patients included in the list 44 are to be subjected to testing in respect of selection criteria 2. In the case of the patient 8a, his general practitioner is contacted who confirms that the patient 8a really does not suffer from chronic high blood pressure. The patient 8a is therefore selected as an actual study participant. Of course, the patient's consent has to be obtained before he can be enrolled in the clinical study.

As secondary criterion 32, it is also possible to use terms relating to the selection criterion 2. If, in a second example, the selection criterion 2 contains the diagnosis “cancer” as inclusion criterion, then a secondary criterion 34f is stored in the form of a word list comprising “cancer”, “oncological finding”, “tumor”, “flower-shaped” or “cauliflower-shaped”. In such a case, patient data 6a-f are searched on path 36 for the presence of the terms stored in the subcriterion 34f by way of a classification algorithm, e.g. the incidence of the occurring words is counted, and, from this, a selection measure 16 is assigned to the patients 8a-f concerned.

In the case just mentioned, the subcriterion 34g can additionally include image-processing parameters which, from an X-ray, permit the automatic detection of a tumor and thus likewise allow a patient 8a-f to be assigned a corresponding selection measure 16 in respect of an X-ray image.

Generally, the secondary criterion 32 can include all criteria and evaluation methods in combination with these which permit an automatic assignment of a selection measure 16 to a patient 8a-f on the basis of the patient data 6a-f.

By way of a further path 46, the database 4 can also be searched in respect of an additional criterion 48. The additional criterion 48 is independent of the selection criterion 2, which must be fulfilled unconditionally and which in this sense represents a “must criterion”, and therefore forms a “can criterion”. An additional criterion 48 can, for example, contain empirical values across clinical studies in general, which groups of persons are particularly suitable for clinical studies, e.g. always provide reliable measured values, are thorough, follow the study through to the end or conscientiously attend appointments. For all such additional criteria 48, the patients 8a-f can be assigned reliability measures 50 which, in final step 22 or confirmation step 42, allow the selected patients 8a-f to be arranged in order there. Of the patients who satisfy all the selection criteria 2 by 100%, the more reliable patients, i.e. those with a higher reliability measure 50, can in fact first be enrolled into the study in final step 22, so as to be able to recruit the most reliable study participants possible.

In the confirmation step 42, the more reliable patients with a higher reliability measure 50, but with the same selection measure 16, can be examined for their actual suitability for the study.

Likewise, the reliability measures 50 can be used directly for weighting the selection measures 16 and can thus already be taken into consideration in test step 18.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for selecting a potential participant for a medical study on the basis of a selection criterion, the method comprising:
electronically storing patient data assigned to a patient;
assigning a secondary criterion to the selection criterion;
electronically evaluating the patient data on the basis of the secondary criterion;
determining, based on the electronic evaluation, a measure for fulfilling the selection criterion for the patient associated with the patient data; and
selecting the patient as a potential participant on the basis of the determined measure.

2. The method as claimed in claim 1,
wherein the secondary criterion is assigned to the selection criterion in accordance with known medical correlations.

3. The method as claimed in claim 1, wherein
the secondary criterion is assigned to the selection criterion in accordance with linguistically employed medical terms, and
the patient data are evaluated on the basis of the secondary criterion with a classification algorithm.

4. The method as claimed in claim 1, wherein
the secondary criterion is assigned to the selection criterion in accordance with nonmedical correlations concerning the medical study.

5. The method as claimed in claim 1, wherein
a probability value of 100% or 0% is determined as the measure, and
the patient selected as a potential participant is selected as an actual participant or is rejected.

6. The method as claimed in claim 1, wherein
a probability value except 100% and 0% is determined as the measure,
for the patient selected as a potential participant, a measure with a probability value of 100% or 0% is determined on the basis of other than the stored patient data, and
the patient selected as a potential participant is selected as an actual participant or is rejected.

7. The method as claimed in claim 1, wherein
unstructured medical documents assigned to a patient are digitalized and stored as patient data.

8. The method as claimed in claim 2, wherein
the secondary criterion is assigned to the selection criterion in accordance with linguistically employed medical terms, and
the patient data are evaluated on the basis of the secondary criterion with a classification algorithm.

9. The method as claimed in claim 2, wherein
the secondary criterion is assigned to the selection criterion in accordance with nonmedical correlations concerning the medical study.

10. The method as claimed in claim 3, wherein
the secondary criterion is assigned to the selection criterion in accordance with nonmedical correlations concerning the medical study.

11. The method as claimed in claim 8, wherein
the secondary criterion is assigned to the selection criterion in accordance with nonmedical correlations concerning the medical study.

12. The method as claimed in claim 2, wherein
a probability value except 100% and 0% is determined as the measure,
for the patient selected as a potential participant, a measure with a probability value of 100% or 0% is determined on the basis of other than the stored patient data, and
the patient selected as a potential participant is selected as an actual participant or is rejected.

13. The method as claimed in claim 3, wherein
a probability value except 100% and 0% is determined as the measure,
for the patient selected as a potential participant, a measure with a probability value of 100% or 0% is determined on the basis of other than the stored patient data, and
the patient selected as a potential participant is selected as an actual participant or is rejected.

14. The method as claimed in claim 4, wherein
a probability value except 100% and 0% is determined as the measure,
for the patient selected as a potential participant, a measure with a probability value of 100% or 0% is determined on the basis of other than the stored patient data, and
the patient selected as a potential participant is selected as an actual participant or is rejected.

15. The method as claimed in claim 2, wherein
unstructured medical documents assigned to a patient are digitalized and stored as patient data.

16. The method as claimed in claim 3, wherein
unstructured medical documents assigned to a patient are digitalized and stored as patient data.

17. The method as claimed in claim 4, wherein
unstructured medical documents assigned to a patient are digitalized and stored as patient data.
